(19) United States
(12) Patent Application Publication
(10) Pub. No.: US 2009/0216613 A1
(43) Pub. Date: Aug. 27, 2009

(54) Availability Check for a Ware

(75) Inventors: Jochen Steinbach, Bad Schoenborn (DE); Andreas Poth, Weingarten (DE)

Correspondence Address: FISH & RICHARDSON, P.C., PO BOX 1022, MINNEAPOLIS, MN, 55440-1022, US

(73) Assignee: SAP AG

(21) Appl. No.: 12/037,579

(22) Filed: Feb. 26, 2008

(51) Int. Cl. G06Q 10/00

(52) U.S. Cl. 705/10

(57) ABSTRACT

Computer-implemented methods, and associated computer program products and systems, are described for checking availability of a ware for a set of demands requesting the ware. In one aspect, the computer-implemented method includes obtaining a first data structure comprising dates in a predetermined time interval, supply information for the ware associated with those dates and demand information for the ware associated with those dates. The method also includes determining, for each of those dates in reverse order starting from a last date of that predetermined time interval, whether an overconfirmation for the ware is present on a specific date. This is done by comparing the supply information and the demand information. When an overconfirmation is present on the specific date, the overconfirmation is eliminated before proceeding with any subsequent overconfirmation determination by reassigning at least one demand on or before that specific date to a date after that specific date.

### TECHNICAL FIELD

This document relates to computing systems and methods executed therein to perform availability check of a ware.

### BACKGROUND

A supply chain management computing system may be used to plan, implement and control the operations of a supply chain as efficiently as possible and may span all movement and storage of raw materials, inventory, and finished products.

Availability check, also known as ATP (availability-to-promise) check, is an important tool within supply chain management in order to provide an answer to the question if a requested quantity of a ware, for example a material or product, is available on a requested date. For determining if a ware is available, or if an overconfirmation is present otherwise, stock, planned inward movements and planned outward movements, like for example sales orders, may be considered. In the case of customer demand, a sales order is a customer request to the company for the delivery of wares, for example goods or services, at a certain time.

Availability may be checked for only one demand, or also referred to as requirement, by only taking the information for that specific demand into consideration (single availability check). This may for example be used in make-to-order environments where a product is created according to a specific customer demand. However, in the case of make-to-stock environments, as for example in mass production, it may be desirable to check the availability for multiple demands (collective availability check), for example sales orders coming in from multiple customers. In this case, competing demands have to be considered and, by using availability check, confirmations may be issued accordingly which can comprise a confirmed delivery date and a confirmed quantity.

In an example manufacturing supply chain management computing system, the system may include a collective availability check suitable for checking the availability of a material or product for multiple demands at the same time. In a typical case, such a collective availability check involves a single availability check for each of the demands. This may be done by first deleting the data for all demands, also referred to as deconfirmation, meaning the deletion of the date and the quantity that had been confirmed up to that point of time. Subsequently, all demands may be reassigned. This may be done by checking all demands in the sequence in which they are ordered in a corresponding priority list, according to a priority each demand is given in relation to other demands. The demands may not be released until the last demand has been reassigned. For companies where there is a large number of demands, the collective availability check may consequently take a long time, since all demands are deconfirmed and a single availability check is carried out for each one anew. Additionally, with this availability check it is difficult to consider only subsets of demands, for example just those demands relevant for a specific time interval.

### SUMMARY

Computer-implemented methods, and associated computer program products and systems, are disclosed for checking availability of a ware for a set of demands requesting the ware. The methods may be referred to as collective availability checks that are performed for multiple demands.

In one aspect, the computer-implemented method includes obtaining a first data structure comprising dates in a predetermined time interval, supply information for the ware associated with those dates and demand information for the ware associated with those dates. The method also includes determining, for each of those dates in reverse order starting from a last date of that predetermined time interval, whether an overconfirmation for the ware is present on a specific date. This is done by comparing the supply information and the demand information. When an overconfirmation is present on the specific date, the overconfirmation is eliminated before proceeding with any subsequent overconfirmation determination by reassigning at least one demand on or before that specific date to a date after that specific date.

In various implementations, the methods may include one or more of the following features. The method may include obtaining a second data structure comprising that set of demands and including priority information for the demands, and, when the overconfirmation is present on the specific date, selecting the demand in the second data structure with a lowest priority to be reassigned. Reassigning that at least one demand may comprise reassigning the demands in the second data structure starting from the demand with the lowest priority until the overconfirmation is no longer present on that specific date. Furthermore, the demands may comprise a confirmation date (or confirmed date) indicating on which date each demand is to be met and a confirmation quantity (or confirmed quantity) indicating a quantity requested by said demand for said confirmation date. In such a case, reassigning the at least one demand may comprise changing the confirmation date of said demand to the date after said specific date. Alternatively or additionally, reassigning the at least one demand may comprise splitting the demand, when the confirmation quantity of said demand is greater than the amount of overconfirmation on said specific date. This may be done by changing the confirmation date to the date after that specific date for a first part of the confirmation quantity equaling an amount of the overconfirmation. For a second part of the confirmation quantity exceeding the amount of the overconfirmation the confirmation date remains unchanged. In addition, the supply information may comprise a cumulated supply cumulated starting from a first date of the predetermined time interval and the demand information may comprise a cumulated demand cumulated starting from the first date. In such a case, the method may comprise generating an overconfirmation information indicating that the overconfirmation is present when the cumulated demand on that date exceeds the cumulated supply on that date. Accordingly, the overconfirmation information may indicate that no overconfirmation is present when the cumulated demand equals or is smaller than the cumulated demand on that date. Finally, the set of demands may comprise at least one of the following: sales orders, service orders, stock transfer demands, internal demands and component demands of production orders and planned production orders.

In another aspect, a computer program product is disclosed. The computer program product is tangibly embodied in a computer-readable storage medium and includes instructions that, when executed, perform operations for checking availability of a ware for a set of demands requesting the ware as described in connection with the methods described above. In yet another aspect, systems are disclosed that are capable of checking availability of a ware for a set of demands requesting the ware as described in connection with the methods described above.

Implementations can provide any, all or none of the following advantages. Considering that there can be a large number of demands and a large number of supply deliveries, the computation time of a method for collective availability check should be short in order to issue confirmations to the customers as quickly and as updated as possible. By determining, for each date in reverse order starting from the last date, whether an overconfirmation is present on a specific date and reassigning at least one demand to a later point of time than the specific date, it is possible to ensure that a demand is touched at most once during collective availability check, which is important for the performance of the method. Also, demands of higher priority in the priority list do most likely not need to be touched. Only a subset of all demands, the least important demands, are reassigned while all other demands, the most important demands, keep their original confirmation date and quantity, which is again important for the performance of the method. Consequently, due to improved performance, it is possible to perform availability check at almost every point of time (for example also during working time which is mostly during day time) in a considerably short amount of time, of course depending on the amount of data to be checked. Furthermore, since the availability check is based on checking a predetermined time interval, any time interval, including very short time intervals, can easily be checked. For planning purposes within supply chain management for example, the planner is thus very flexible in defining a time interval to be checked. Defining a time interval to be checked may for example be performed as part of a delivery release process towards the execution date. In such a case, checking a short time interval near the execution date may directly be included in the delivery release process and the feasibility of the delivery request may be ensured.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary system in which a supply chain management computing system is used.

FIG. 2A-B are diagrams that illustrate an exemplary occurrence of overconfirmations within supply chain management.

FIG. 3 is a flow diagram of an exemplary use of collective availability check.

FIG. 4 is a flowchart showing a computer-implemented method for checking the availability of a ware for a set of demands.

FIGS. 5, 6 and 7A-7B are flowcharts with further details of an example method used in the method of FIG. 4.

FIG. 8A-C are diagrams showing an example execution of a computer-implemented method for checking the availability of a ware for a set of demands.

FIG. 8D shows a priority list and resulting confirmation dates corresponding to the example execution of FIG. 8A-D.

FIG. 9A-B are diagrams showing another example execution of a computer-implemented method for checking the availability of a ware for a set of demands.

FIG. 9C shows a priority list and resulting confirmation dates corresponding to the example execution of FIG. 9A-B.

FIG. 10A-C are exemplary supply-demand data structures and priority data structures of exemplary steps in a computer-implemented method for checking the availability of a ware for a set of demands.

FIG. 11 is a block diagram of a computing system that can be used in connection with the data structures and computer-implemented methods described in this document.

Like reference symbols in the various drawings indicate like elements.

### DETAILED DESCRIPTION

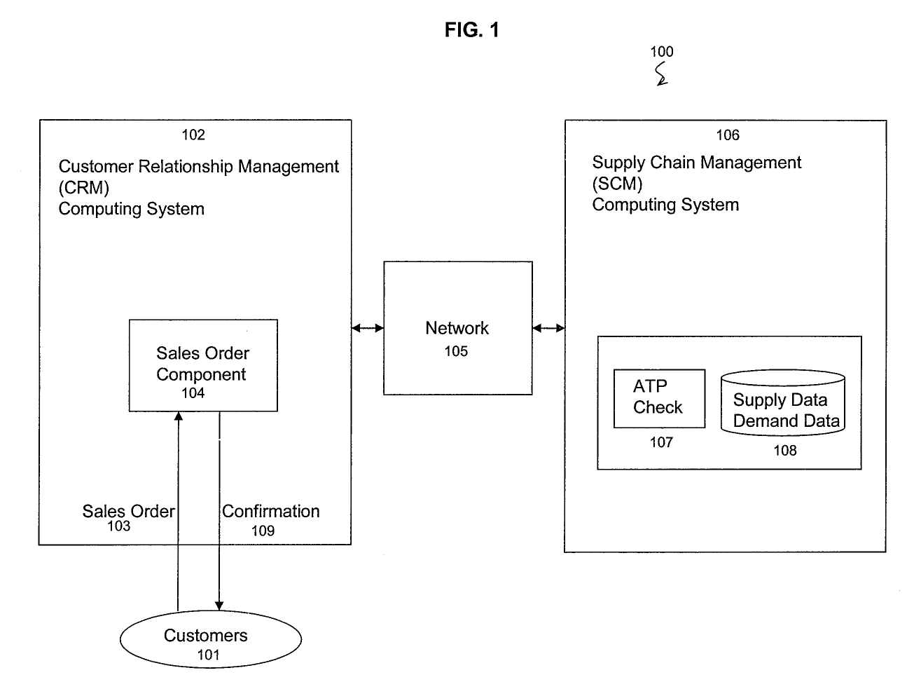

FIG. 1 is a block diagram of an exemplary system 100 in which a supply chain management (SCM) computing system 106 is used. Customers 101 may place sales orders 103, forming a demand requesting a ware in this example. The sales orders are sent to a sales order component 104 within a customer relationship (CRM) computing system 102. The sales order data, or also referred to as demand data, may be sent via a network 105 or any other suitable means to supply chain management system 106. An ATP (Availability-to-promise) check component 107, or also referred to as availability check component, may be part of supply chain management computing system 106.

Even though the demands referred to in FIG. 1 are sales orders placed by customers, collective availability check may also be used for other kinds of demands. For example for internal processes within a company, the demands may be stock transfer demands, internal demands or component demands of production (manufacturing) orders and planned production orders. The supplies may be purchase orders, planned purchase orders and the outcome of production orders and planned production orders.

While this and other examples herein refer to products being supplied and/or demanded, other wares than products can be considered as well. In other implementations, wares such as services can be supplied and/or demanded, for example in a computer system that schedules availability of consultants or other professionals.

ATP check component 107 may be placed within any suitable platform or system. In one implementation, the ATP check component may be placed within an Enterprise Resource Planning (ERP) System, for example the R/3 system by SAP AG, Walldorf, Germany. In another implementation, the ATP check component may be placed within an Advanced Planning and Information (APO) system, for example the APO system by SAP AG, Walldorf, Germany. In yet another implementation, the ATP check may be placed within a system for small and medium sized businesses, like for example a Business By Design system by SAP AG, Walldorf, Germany.

ATP check component 107 may be able to access supply and demand data 108 and to perform a collective product availability check for a set of demands. When there are multiple demands for a ware, it might be the case that more demand is confirmed on a certain date than supply is available on that specific date. In such a case, an overconfirmation is present on that date. Overconfirmations may for example occur when a change is made in the supply and demand data, for example when a requested date or quantity of a demand is changed or when a supply delivery changes. Demands that had a confirmed date and quantity up to that point of time, might no longer be confirmed after a change in the supply and demand data has occurred.

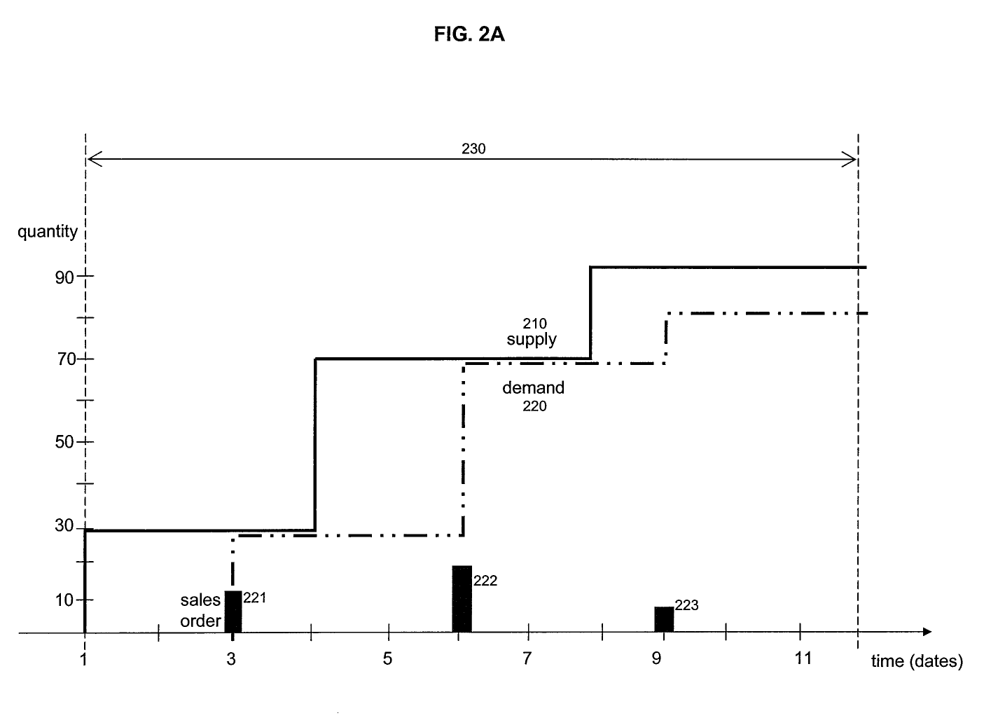

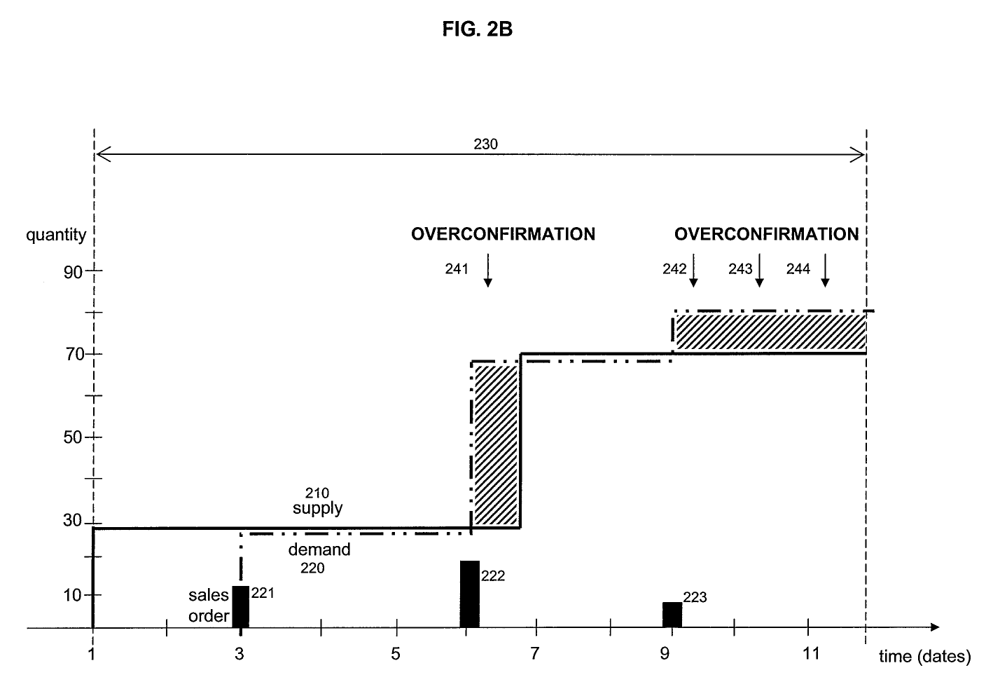

Referring to FIG. 2A-B, an exemplary occurrence of overconfirmations within supply chain management by delay of one or more supply deliveries is illustrated. In FIG. 2A a supply-demand diagram is shown for a first point of time. A cumulated supply 210 and a cumulated demand 220, also referred to as supply and demand time series, are plotted over a certain time interval 230. Cumulated here indicates that all supplies, and demands respectively, are cumulated starting from the first date of the time interval 230, which is date 1 in this example. The time may be measured in any suitable measure, like for example any discrete dates or time periods. Cumulated supply and demand form together a so-called ATP time series which may indicate if an overconfirmation is present at a certain time.

In FIG. 2A, referring to the cumulated supply 210, the stock on date 1 is of quantity 30. On date 4, a first supply delivery of quantity 40 is received, forming a cumulated supply of 70. There is a second supply delivery of quantity 20 on date 8, leading to a total cumulated supply of 90 at the end of time interval 230. Referring to the cumulated demand 220, a first sales order 221 of requested quantity 30 (quantities are indicated by height of sales order in a not to scale manner) has requested delivery date 3. A second sales order 222 of quantity 40 has requested delivery date 6 and a third sales order of quantity 10 should be delivered on date 9. In the example of FIG. 2A, the cumulated demand 220 is always equal to or smaller than the cumulated supply 210. Therefore, no overconfirmations are present in the example shown in FIG. 2A.

In FIG. 2B a supply-demand diagram is shown for a second point of time, when planned supply deliveries have been delayed. The first supply delivery on date 4 of FIG. 2A has been delayed by three dates, now being delivered on date 7. The second supply delivery on date 9 of FIG. 2A cannot be delivered at all within that specific time interval 203. Accordingly, for the second sales order 222 in FIG. 2A having requested delivery date 6, there is not sufficient supply to fulfill that demand on that date in FIG. 2B. Consequently, an overconfirmation 241 with an amount of 40 (indicated by the hatched area) is identified on date 6. The overconfirmation is indicated by the cumulated demand 220 extending higher than the cumulated supply 210 at one or more dates. For the third sales order 223 in FIG. 2A having a requested delivery date 9, again there is not enough supply available. Therefore, in FIG. 2B, overconfirmations 242, 243 and 244 with an amount of 10 are identified for dates 9, 10 and 11, respectively.

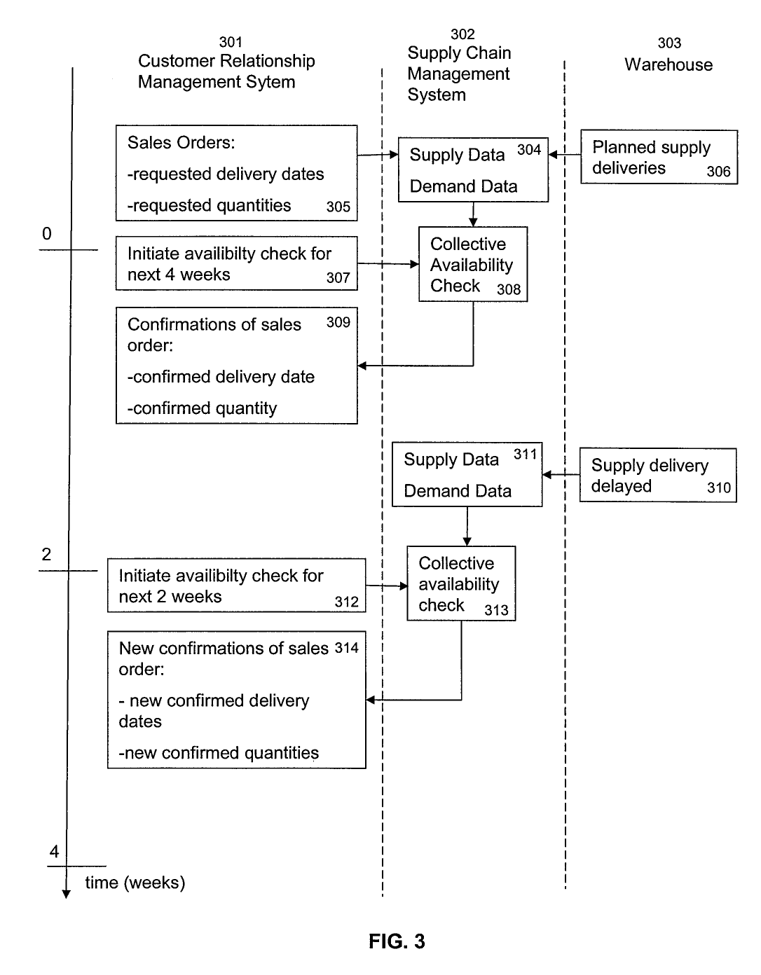

FIG. 3 is a flow diagram of an exemplary use of collective availability check when a supply delivery is delayed. Supply and demand data 304 is provided in form of sales orders 304, received from a customer relationship management system 301 for example, and planned supply deliveries 306, received from a warehouse 303 for example. It may be assumed that for a first point of time, indicated by week 0 on the time axis, a collective availability check 308 for all sales orders with a requested delivery date within the next 4 weeks for example is initiated. In this example this is done by customer relationship management system 301, using a command 307. In such a case, confirmations 309 for all checked sales orders, including a confirmed delivery date and a confirmed quantity, are output by collective availability check 308. The confirmed delivery dates of the sales orders may correspond to the requested delivery dates, and the confirmed quantities to the requested quantities respectively, when no overconfirmation is present within the next four weeks.

Assuming that when time proceeds, an information 310 is received that a planned supply delivery is delayed. Supply and demand data 304 is updated and forms updated supply and demand data 311. When a collective availability check 313 is then initiated for a second point of time for all sales orders with a requested delivery date within the next two weeks for example, using a command 312, not all sales orders might get their requested, and up to that point of time confirmed, delivery date or quantity due to the occurrence of overconfirmation. Accordingly, new confirmation 314 for at least one sales order, including a new confirmed delivery date and quantity, may be issued to customer relationship management 301.

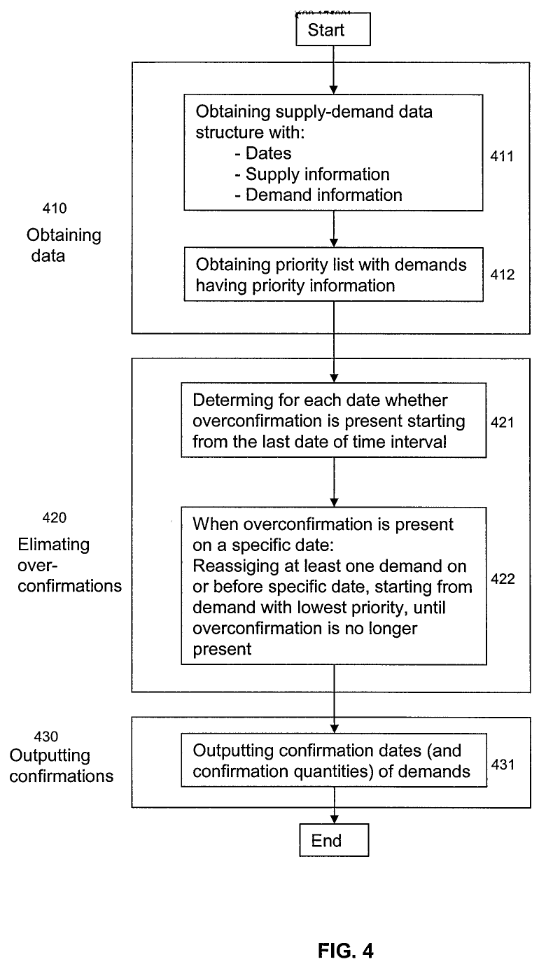

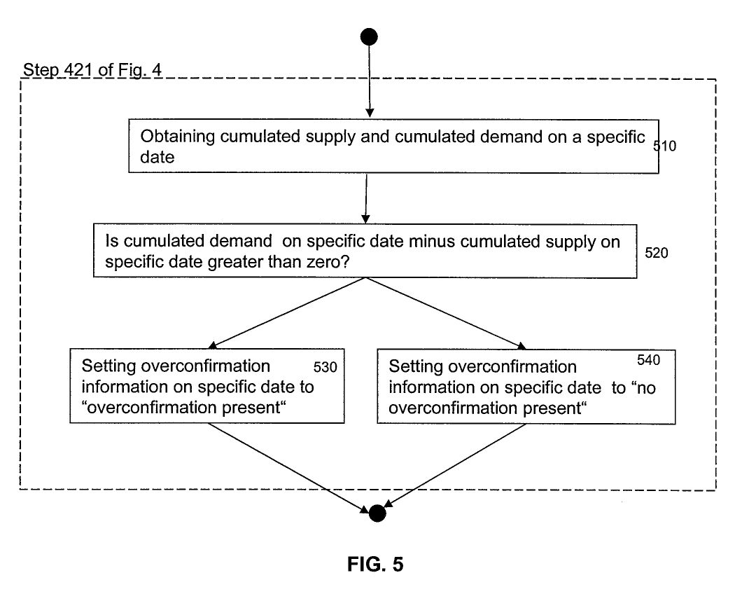

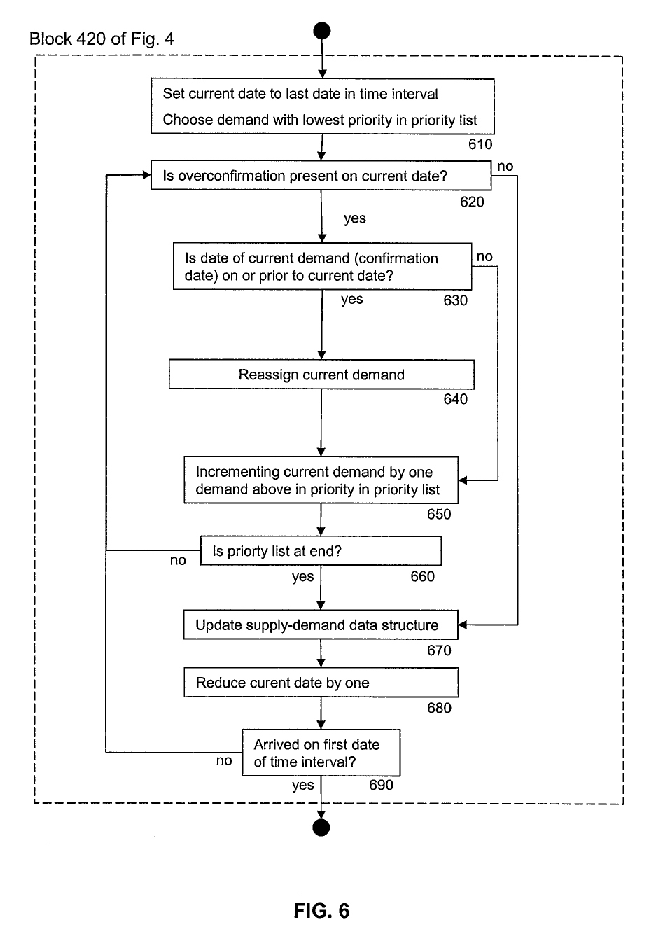

In FIG. 4 a flowchart showing a computer-implemented method for checking availability of a ware for a set of demands is shown. In a first block 410, data is obtained and in a second block 420 overconfirmations are eliminated. Optionally, results like confirmation dates, and possibly also confirmation quantities, of the demands may be output (block 430).

The first block 410 of obtaining data includes, in step 411, obtaining a supply-demand data structure comprising dates in a certain time interval as well as supply and demand information associated with those dates. In step 412, a priority list, or priority data structure, may also be obtained, which includes the set of demands and priority information for the demands. Steps 411 and 412 of obtaining data structures may be performed in any possible sequence or may be performed simultaneously.

Priority of a demand may be determined in any suitable way of determination. This may for example include the use of a suitable function depending on one or more parameters. Examples of parameters are requested delivery date or importance of the customer. In this way, the demands may be ordered according to their importance. In some implementations, a user can specify the priority for each demand, either when the demand is entered in the system or otherwise. The most important demand to be fulfilled is given highest priority in the priority list, wherein the demand having least importance is given lowest priority in the priority list.

Eliminating overconfirmations (block 420) includes, in step 421, first determining for each date whether an overconfirmation is present or not, starting from the last date of the time interval. Last date means in this context the latest date of the time interval, for example the last day of a month for a time interval of a month. The time interval is checked going back in time. While checking in this sequence, it is desired to identify the dates on which an overconfirmation is present. In step 422, when an overconfirmation is present on a specific date, at least one demand on or before that specific date is reassigned, starting from a demand with a lowest priority. Demands can be reassigned until the overconfirmation is no longer present on that specific date. Demands of higher priority in the priority list do not need to be touched. In this way, only the least important demands are reassigned while the most important demands keep their confirmation date and quantity. Reassigning at least one demand, when an overconfirmation is detected, is performed until no more overconfirmation is present in the time interval. By determining, for each date in reverse order starting from the last date, whether an overconfirmation is present on a specific date and reassigning at least one demand to a later point of time than the specific date, it is possible to ensure that each demand is touched at most once during collective availability check, which is important for the performance of the method.

In step 431 of block 430, the results of the collective availability check, like confirmation dates and possibly also confirmation quantities, may be output to the customers for example. Outputting the results may be done in any suitable manner.

FIG. 5 shows an exemplary implementation of step 421 in FIG. 4 for determining whether an overconfirmation is present or not. For a specific date, the cumulated supply and cumulated demand, derived from or included in the supply and demand information respectively, is obtained in step 510. In step 520, subtracting the cumulated supply on the specific date from the cumulated demand may give an information whether an overconfirmation is present or not, which may be called an overconfirmation information. If the result of the subtraction has a positive sign, the cumulated demand exceeds the cumulated supply on that specific date and the overconfirmation information is set to “overconfirmation present” for example (step 530). If the result of the subtraction is zero or has a negative sign, the cumulated demand is equal or smaller than the cumulated supply on that specific date and the overconfirmation information is set to “no overconfirmation present” for example (step 540). However, the overconfirmation information may be of any suitable type, like “TRUE” and “FALSE” or other binary values for example. The overconfirmation information can optionally also comprise the amount of overconfirmation.

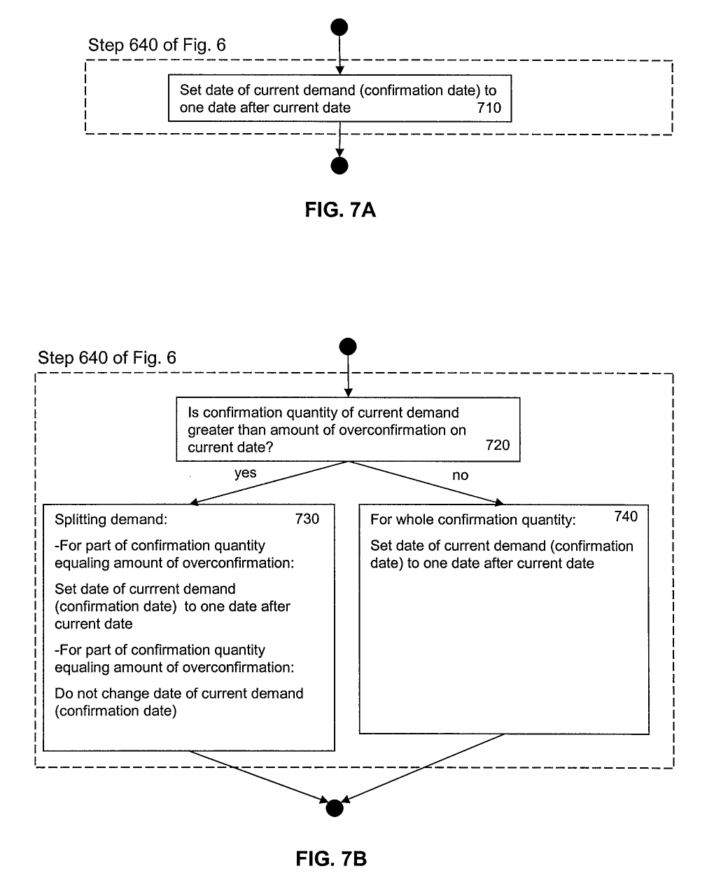

FIG. 6 shows in more detail exemplary method steps for eliminating overconfirmations in block 420 of FIG. 4. In a first step 610, the current date is set to the last date in the time interval in order to be able to check the time interval starting from the last date and going back in time. Furthermore, the current demand is set to the demand with the lowest priority in the priority list in order to be able to check the priority list starting from the demand with the lowest priority and going up in priority. It is then determined, in step 620, if an overconfirmation is present on the current date. This may be done by evaluating an overconfirmation information for the current date, which may have been determined or may be determined by the method of FIG. 5 for example. If no overconfirmation is present, the method turns directly to step 670.

However, if an overconfirmation is present on the current date, the method determines, in step 630, if the date of the current demand, for example the confirmed delivery date of the demand, is on or before the current date. If it is after, meaning later, than the current date, that demand has no influence on the overconfirmation on the current date and the method selects the next demand in step 650. However, if the date of the current demand is on or prior to the current date, the current demand is reassigned in step 640. After incrementing the current demand by one demand above in priority (step 650), it is determined if all demands in the priority list have already been checked in step 660. If this is not the case, the method returns to step 620 and determines if there is still an overconfirmation present on the current date. If so, one or more demands need to be reassigned as explained with reference to steps 630 to 660 above.

If no more overconfirmation is present, the method turns to step 670 and updates the supply-demand data structure, in order to account for changes in the supply and demand data, for example caused by demands that have been reassigned in a preceding iteration. In step 680, the current date is then reduced by one and as long as the current date has not arrived at the first date of the time interval, or any other suitable termination condition is achieved, the method repeats steps 620 to 680 in the manner described above. When the method terminates, all overconfirmations within the time interval have been eliminated.

FIGS. 7A and 7B illustrate two example implementations of step 640 in FIG. 6 for reassigning the current demand. In FIG. 7A only the date of the current demand, also referred to as confirmation date, is considered. The confirmation date is set to one date after the current date in order to eliminate the overconfirmation on the current date (step 710). In such a case, if the demand comprises a confirmation quantity, the whole confirmation quantity of the demand is reassigned.

In FIG. 7B, not only the date but also the quantity of the current demand is examined. In step 720, it is determined whether the confirmation quantity of the current demand is greater than the amount of overconfirmation on the current date or not. If the confirmation quantity is greater than the amount of overconfirmation, the demand may be split (step 730). For the part of confirmation quantity equaling the amount of overconfirmation, the date of the current demand (confirmation date) is set to one date after the current date. However, for the part of confirmation quantity exceeding the amount of overconfirmation, the confirmation date remains the same. In this way, only the necessary amounts are reassigned. However, if the confirmation quantity is equal or smaller than the amount of overconfirmation, the date of the current demand is set to one date after the current date for the whole overconfirmation quantity in step 740, corresponding to what has been explained with reference to FIG. 7A.

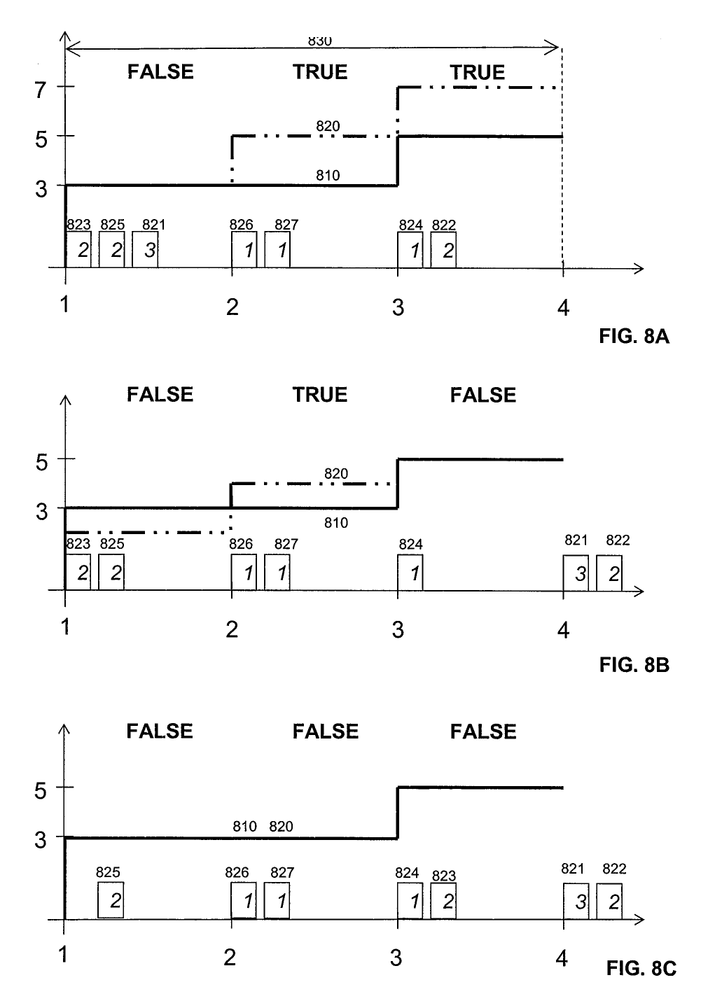

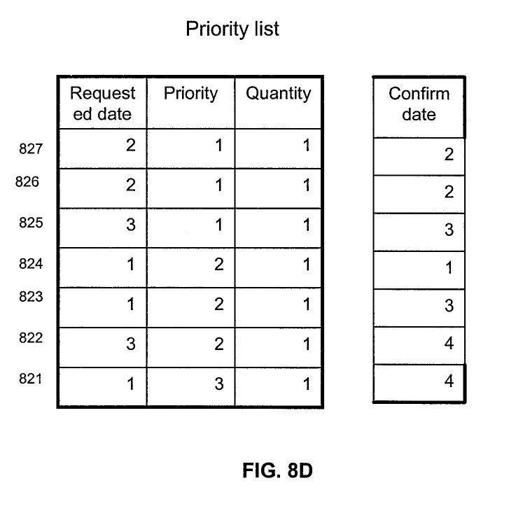

FIG. 8A-C schematically show an example execution of the collective availability check which has been described in connection with FIGS. 4, 5, 6A-B and 7A-B. A cumulated supply 810 and a cumulated demand 820 are plotted over a time interval 830 ranging from date 1 through date 3. There are in this example seven demands 821 to 827 having different priorities (numbers given in rectangles reflect the priorities). The priorities are also marked in the corresponding priority list of FIG. 8D. The priority list of FIG. 8D includes the requested date of each demand, its priority given and the quantity. For simplification purposes, in this example, the confirmation quantity of a demand is always set to one, but in other examples could be any number. The priority list may also include the confirmed date for each demand, and this information may also be stored in any other suitable data structure. Two or more demands can have the same priority as can be seen in the priority list of FIG. 8D. The sequence in which they appear in the priority list may be determined by any suitable priority condition.

At the beginning of the method, in FIG. 8A, there is an amount of overconfirmation of two units on the current date being the last date, in this case date 3. The method checks the priority list starting from the demand with the lowest priority, which is demand 821 in the priority list of FIG. 8D since its priority is 3. This demand is reassigned, in order to eliminate the overconfirmation, to one date after the current date which is date 4 in this case, a date outside the time interval 1 to 3 which needs to be checked. However, reassigning demand 821 reduces the amount of overconfirmation on date 3 to one unit, but does not entirely eliminate the overconfirmation. Therefore, one demand above in priority in the priority list has to be reassigned in the same manner, which is demand 822 having priority 2. By reassigning those two demands, the overconfirmation of two units on date 3 is eliminated as can be seen in FIG. 8B. The supply and demand data is then updated. Updating the supply and demand data may also be performed each time a demand has been reassigned.

As can be seen from this example, a demand can also be reassigned to a date outside the time interval to be checked. In a case where the time interval to be checked represents the whole time interval for which demand and supply data is available and where the total cumulated demand exceeds the total cumulated supply (as indicated in FIG. 8A-C), it is possible to simply deconfirm the demand (or the demands) that falls out of the time interval. This demand can then not be covered by the supply that is available and can therefore not be confirmed at all. The deconfirmation of the demand may be understood as being the step of reassigning the demand to a later date, a date outside the time interval.

Referring to FIG. 8B, the current date is then reduced by one. On date 2, there is an overconfirmation of one unit. Again, the priority list is checked starting from the demand with lowest priority. Demands 821 and 822 have a confirmation date which is after current date 2. Therefore, the method starts checking demand 723 having requested, and up to that point of time confirmed, date 1 and reassigns that demand to date 3. By doing this, after the supply and demand data is updated, the overconfirmation on date 2 is eliminated, as can be seen in FIG. 8C. When checking date 1, no more overconfirmation is detected and the method terminates. Thus, the detected overconfirmations were eliminated by performing three reassignments of demands, out of a total of seven scheduled demands. In this example, the remaining four demands were not touched or otherwise processed in the operations.

When using the method described above for eliminating overconfirmations, the first iteration is to check the last date of the time interval. This first iteration plays an important role, in that the amount of overconfirmation, which has cumulated up to the last date, is eliminated by reassigning demands to a date after the last date, behind the so called check horizon. These demands, which are the least important ones, are not considered in the time interval of interest anymore. The first iteration therefore removes the exceeding demand present within the time interval of interest. All preceding iterations for earlier dates may also involve reassignment of demands, keep the demands within the time interval of interest.

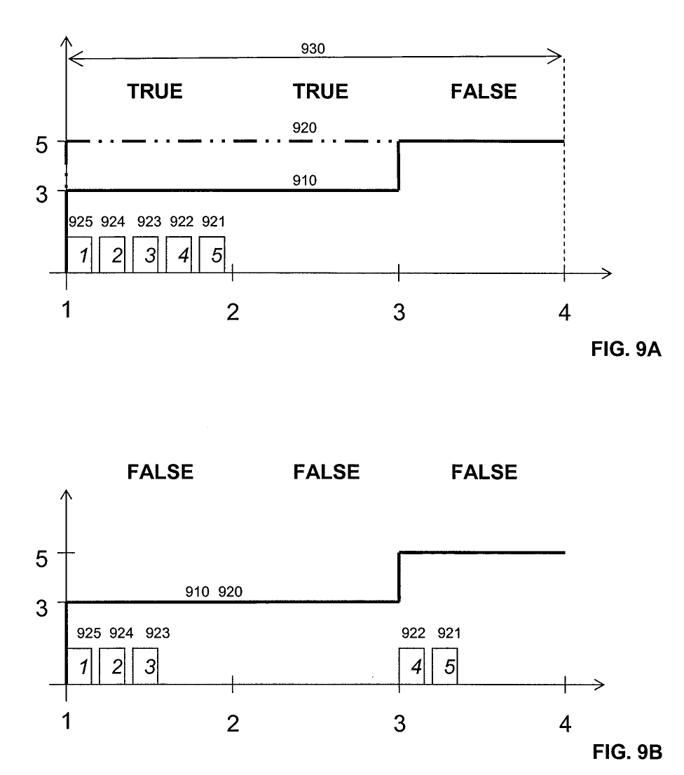

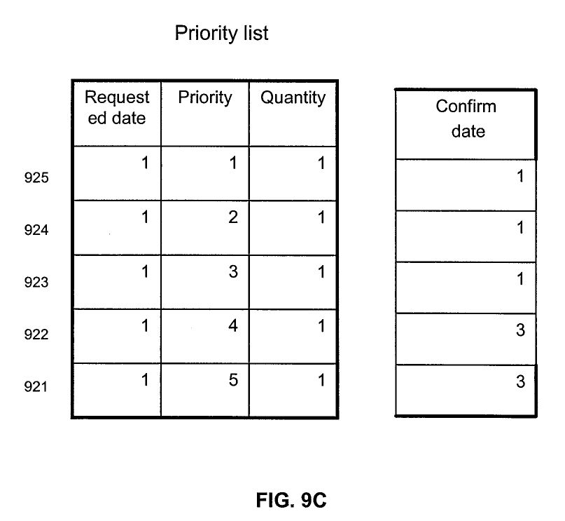

FIG. 9A-9B show a simple example of a case where the demands are merely reassigned within the time interval of interest 930. As can be seen in FIG. 9A, on the last date, date 3 in this case, no overconfirmation is detected. Cumulated demand 920 does not exceed cumulated supply 910 on that date and the overconfirmation information is set to “FALSE”. On date 2 however, an overconfirmation of amount 2 is detected. Therefore, demands 921 and 922, having lowest priorities 4 and 5 in the priority list shown in FIG. 9C, are reassigned to date 3, still within time interval 930 and not behind the check horizon. By reassigning demands 921 and 922, the overconfirmation on date 2 is eliminated as can be seen in FIG. 9B which shows the cumulated supply 910 and cumulated demand 920 after an update of the supply and demand data has been performed.

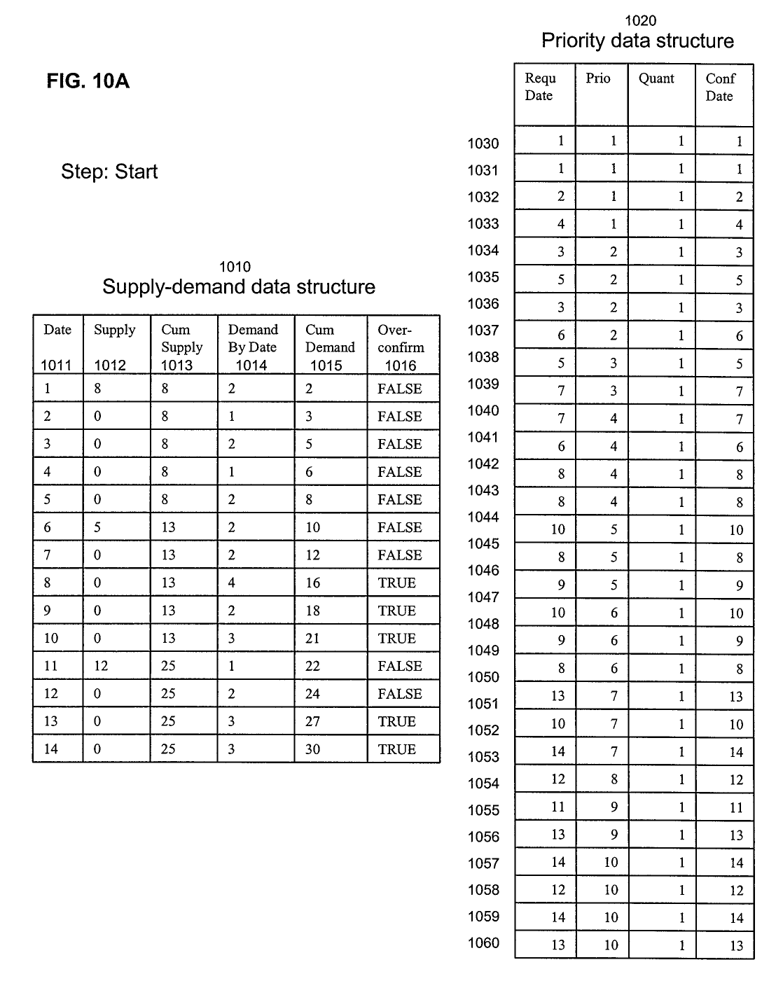

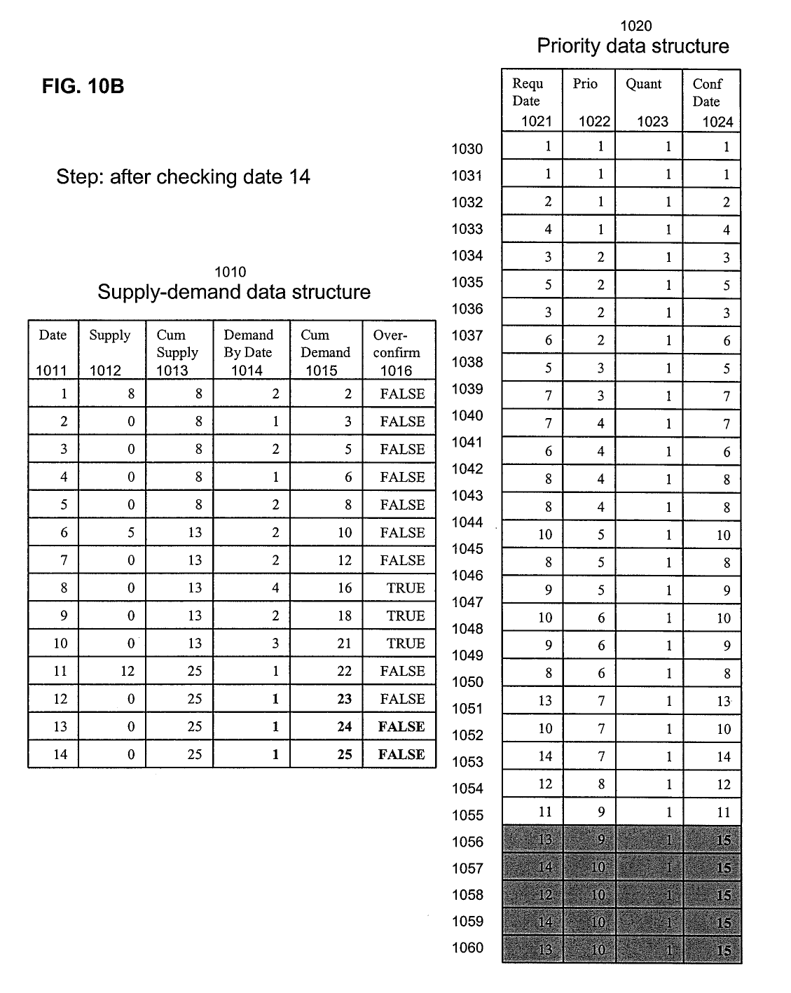

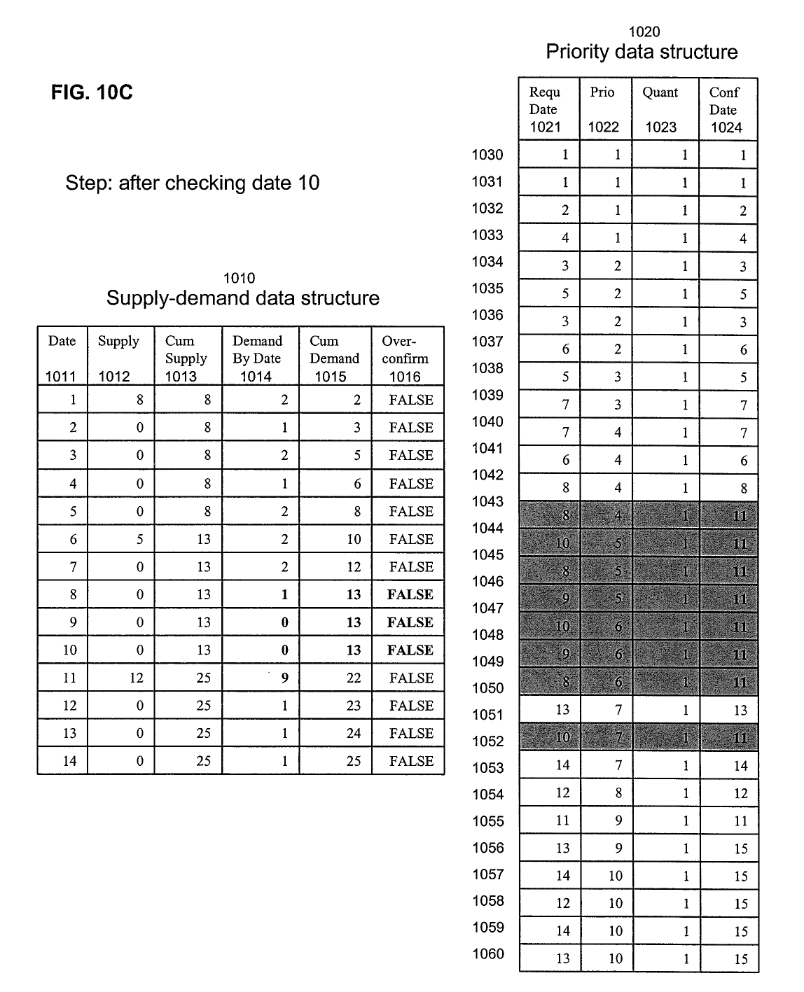

In a practical case of supply chain management, the number of supply deliveries and especially the number of demands can become very high. FIG. 10A-C show exemplary supply-demand data structures 1010 and priority data structures 1020 of exemplary steps in a collective availability check for thirty demands and within a time interval of dates 1 through 14. It should however be noted that these numbers are kept small for illustration purposes.

The supply-demand structure comprises dates 1011, the corresponding supply 1012 and the demand by date 1014 which has been calculated from the priority data structure 1020. The supply-demand data structure further comprises the calculated cumulated supply 1013 and the calculated cumulated demand 1015. An overconfirmation 1016 is then generated by subtracting the cumulated supply 1013 from the cumulated demand 1015. If the result is zero or has a positive sign, the overconfirmation information 1016 is set to “FALSE”, indicating that no overconfirmation is present. If the result is that the cumulated demand exceeds the cumulated supply, the overconfirmation information is set to “TRUE”, indicating that an overconfirmation is present. Accordingly, in FIG. 10A, an overconfirmation is present on dates 8, 9, 10, 13 and 14.

The priority data structure 1020 comprises demands 1030 to 1060, one in each row. Each demand has a requested date 1021, priority information 1022 indicating the priority for the demand and a quantity 1023 (for simplification purposes set to one in this example). At the beginning, for each demand 1030 to 1060 confirmation date 1024 is set to be requested date 1021. However, demands, most likely demands having least priority, might later be reassigned to a later date in one of the preceding iterations. In this example, the higher the number of the priority information 1022 is, the less important the demand is. This means, demands having a low number as priority information 1022, for example 1 for demand 1030, have the highest priority. Accordingly, demands having a high number as priority information 1022, for example 10 for demand 1060, have the least priority. However, it should be noted that the priority information indicating the priority of a demand may be of any other suitable type. Demands can also have the same number as priority information 1022 as can be seen in priority data structure 1020. The sequence in which they appear in the priority data structure 1020 may then be determined by other suitable priority conditions.

When starting to eliminate overconfirmations, the current date is first set to the last date in the time interval. On date 14, an overconfirmation of amount 5 is present. The priority data structure 1020 is checked starting from the demand with the lowest priority, which is demand 1060. Demands 1060 to 1056 are subsequently reassigned to the date after the current date, which is date 15, as indicated by the rows highlighted in gray in priority data structure 1020 of FIG. 10B. Those five demands are reassigned behind the check horizon in order to eliminate the overconfirmation on the last date. The supply-demand data structure 1010 is then updated. Since demands 1060 to 1056 had confirmed dates ranging from 12 to 14 before but now have date 15 as confirmed date, the demand by date 1014 is changed, as indicated in bold letters in supply-demand data structure 1010 of FIG. 10B. Also the cumulated demand 1015 is changed accordingly. As a result, the overconfirmation information 1016 on date 14 as well as on date 13 now indicates that the overconfirmation on those dates has been eliminated, an overconfirmation is no longer present on those dates.

While checking the supply-demand data structure 1010 and going back in time, referring still to FIG. 10B, the next overconfirmation occurs on date 10. The amount of overconfirmation on that date is 8. Subsequently, the priority data structure 1020 is checked, starting again with the demand having least priority. Demands 1060 to 1056 have already been reassigned and consequently do not have a date on or prior to current date 10. Demand 1055 could be reassigned but possesses a date which is not on or prior to current date 10, and thus could not cure the overconfirmation on date 10 even if reassigned. Therefore, demand 1055 is not reassigned. The same is true for demands 1054 and 1053. When arriving at demand 1052, it is determined that its confirmation date is on date 10. Therefore, demand 1052 is reassigned to the date after the current date, which is date 11. This improves, but does not completely eliminate, the overconfirmation so one or more additional demands that can be reassigned are sought.

The next demand in the priority data structure, demand 1051, again has a confirmation date which is not on or prior to the current date. However, demands 1050 to 1043 can be reassigned to the date after the current date, thereby entirely eliminating the overconfirmation on date 10. The eight demands reassigned are marked by the rows highlighted in gray in the priority data structure 1020 of FIG. 10C. The supply-demand data structure 1010 is then updated. Again, as described above, the demand by date 1014 is changed accordingly and consequently also the cumulated demand 1015, as indicated in bold letters in supply-demand data structure 1010 of FIG. 10C. As a result, the overconfirmation information 1016 on date 10 as well as on dates 9 and 8 now indicates that the overconfirmation on those dates has been eliminated, indicated by the value “FALSE”. This has been achieved by reassigning merely thirteen demands, out of a total of thirty demands. Thus, overconfirmations can be eliminated while touching significantly less than all demands.

When applying this method on real data in supply chain management, any desired time interval may be checked and the overconfirmations may be eliminated within this time interval, thereby only considering a minimum subset of the total supply and demand data available. While checking a specific subset might be important in daily use of collective availability check, it may still be desired to check the total supply and demand data once in a while, perhaps not during working time, as at night, when there is enough time and resources available to check big amount of data.

In the following an exemplary software implementation of an exemplary method is illustrated by means of a subroutine named “Check”. For clarity, explanatory comments have been included next to some steps, and these are indicated by italics and by an apostrophe (') at the beginning of the line.

```
Sub Check( )
Dim Supply As Worksheet
Dim Demand As Worksheet
‘Provide supply-demand data structure
Set Supply = Worksheets(“Supply”)
‘Provide priority data structure
Set Demand = Worksheets(“Demand”)
‘Set current demand to least important demand
DemandRow = 30
‘Set current date to last date
SupplyRow = 14
‘Outer loop: Do as long as current date did not reach the first date (today) and as long
as there are still demands left over
Do While SupplyRow > 1 And DemandRow > 1
‘Subtracting cumulated supply from cumulated demand
  Delta = Supply.Cells(SupplyRow, 5) − Supply.Cells(SupplyRow, 3)
  ‘Inner loop: Do as long as there is an overconfirmation present and there are still
      demand s left over
  Do While Delta > 0 And DemandRow > 1
    ‘Determine whether current demand has a confirmation date on or prior to the
      current date having an overconfirmation
    If Demand.Cells(DemandRow, 4) <= Supply.Cells(SupplyRow, 1) Then
      ‘Reassign confirmation date of current demand to current date plus one
      Demand.Cells(DemandRow, 4) = Supply.Cells(SupplyRow, 1) + 1
      ‘Reduce amount of overconfirmation by the confirmation quantity of the
      demand reassigned
      Delta = Delta − Demand.Cells(DemandRow, 3)
    End If
    ‘Go to next demand one above in priority
    DemandRow = DemandRow − 1
  Loop
  ‘Update the supply-demand data (needs to be done when at least one demand has
      been reassigned)
  Supply.Calculate
  ‘Go to next (previous) date
  SupplyRow = SupplyRow − 1
Loop
End Sub
```

First, a supply-demand data structure (“Supply”) and a priority data structure (“Demand”) are obtained in form of worksheets. In this example, the time interval spans 14 dates and 30 demands are present, corresponding to the example set forth with reference to FIG. 10A-C. A current date (“SupplyRow”) is set to the last date 14 of the time interval. A current demand (“DemandRow”) is set to the demand with least priority. Subsequently, an outer loop for checking the time interval starting from the last date may be started. The outer loop is terminated when the current date reaches the first date and there are no more demands left over to be checked. If this is not the case, in a subsequent step the difference (“Delta”) between the cumulated demand and the cumulated supply on the current date is calculated. When the difference is greater zero, indicating that an overconfirmation is present on the current date, and there are still demands left over, the inner loop for checking the priority data structure starting from the demand with least priority may be started. Subsequently, it is determined whether the current demand has a confirmation date on or prior to the current date. If this is the case, the confirmation date of the current demand is reassigned to one date after the current date and the amount of overconfirmation is reduced by the confirmation quantity of the demand that has been reassigned. Then, the current demand is incremented to one demand above in priority in the priority data structure and the inner loop is repeated until the overconfirmation is eliminated on the current date and no more demands are left over to be checked. After exiting the inner loop, the supply-demand data is recalculated or updated. This needs only be done when at least one demand has been reassigned. The procedure then turns to the next, meaning the previous, date and repeats the steps mentioned above until the current date has arrived at the first date and the outer loop is terminated.

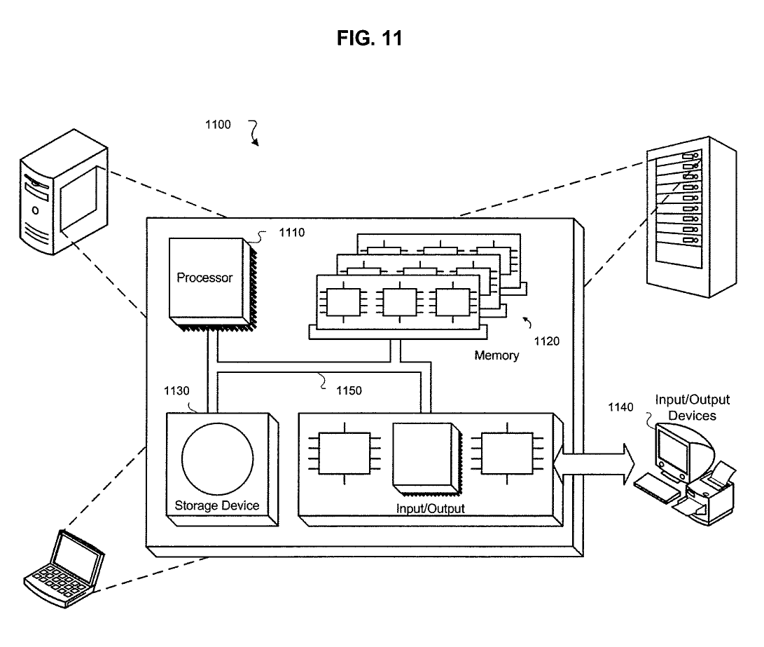

FIG. 11 is a schematic diagram of a generic computer system 1100. The system 1100 can be used for the operations described in association with any of the computer-implemented methods described previously, according to one implementation. The system 1100 includes a processor 1110, a memory 1120, a storage device 1130, and an input/output device 1140. Each of the components 1110, 1120, 1130, and 1140 are interconnected using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130 to display graphical information for a user interface on the input/output device 1040.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 may be a floppy disk device, a hard disk device, an optical disk device, or a tape device.

The input/output device 1140 provides input/output operations for the system 1100. In one implementation, the input/output device 1140 includes a keyboard and/or pointing device. In another implementation, the input/output device 1140 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for checking availability of a ware for a set of demands requesting the ware, the method comprising:
obtaining a first data structure comprising dates in a predetermined time interval, supply information for the ware associated with said dates and demand information for the ware associated with said dates;
determining, for each of said dates in reverse order starting from a last date of said predetermined time interval, whether an overconfirmation for the ware is present on a specific date by comparing the supply information and the demand information; and
when an overconfirmation is present on the specific date, eliminating the overconfirmation before proceeding with any subsequent overconfirmation determination by reassigning at least one demand on or before the specific date to a date after the specific date.

2. The method of claim 1, further comprising:
obtaining a second data structure comprising said set of demands and including priority information for the demands; and
when the overconfirmation is present on the specific date, selecting the demand in the second data structure with a lowest priority to be reassigned.

3. The method of claim 2, wherein reassigning said at least one demand comprises reassigning the demands in the second data structure starting from the demand with the lowest priority until the overconfirmation is no longer present on said specific date.

4. The method of claim 1, wherein said set of demands comprises a confirmation date indicating on which date each demand is to be met and a confirmation quantity indicating a quantity requested by said demand for said confirmation date.

5. The method of claim 4, wherein reassigning the at least one demand comprises changing the confirmation date of said demand to the date after said specific date.

6. The method of claim 4, wherein reassigning the at least one demand comprises, when the confirmation quantity of said demand is greater than the amount of overconfirmation on said specific date, splitting the demand by changing the confirmation date to the date after said specific date for a first part of the confirmation quantity equaling an amount of the overconfirmation, wherein for a second part of the confirmation quantity exceeding the amount of the overconfirmation the confirmation date remains unchanged.

7. The method of claim 1, wherein the supply information comprises a cumulated supply cumulated starting from a first date of the predetermined time interval and the demand information comprises a cumulated demand cumulated starting from the first date.

8. The method of claim 7, further comprising generating an overconfirmation information (1) indicating that the overconfirmation is present when the cumulated demand on said date exceeds the cumulated supply on said date and (2) indicating that no overconfirmation is present when the cumulated demand equals or is smaller than the cumulated demand on said date.

9. The method of claim 1, wherein the set of demands comprises at least one of the following: sales orders, service orders, stock transfer demands, internal demands and component demands of production orders and planned production orders.

10. A computer program product tangibly embodied in a computer-readable storage medium and comprising executable instructions that, when executed, perform operations for checking availability of a ware for a set of demands requesting the ware, the operations comprising:
obtaining a first data structure comprising dates in a predetermined time interval, supply information for the ware associated with said dates and demand information for the ware associated with said dates;
determining, for each of said dates in reverse order starting from a last date of said predetermined time interval, whether an overconfirmation for the ware is present on a specific date by comparing the supply information and the demand information; and
when an overconfirmation is present on the specific date, eliminating the overconfirmation before proceeding with any subsequent overconfirmation determination by reassigning at least one demand on or before the specific date to a date after the specific date.

11. The computer program product of claim 10, further comprising:
obtaining a second data structure comprising said set of demands and including priority information for the demands; and
when the overconfirmation is present on the specific date, selecting the demand in the second data structure with a lowest priority to be reassigned.

12. The computer program product of claim 11, wherein reassigning said at least one demand comprises reassigning the demands in the second data structure starting from the demand with the lowest priority until the overconfirmation is no longer present on said specific date.

13. The computer program product of claim 10, wherein said set of demands comprises a confirmation date indicating on which date each demand is to be met and a confirmation quantity indicating a quantity requested by said demand for said confirmation date.

14. The computer program product of claim 13, wherein reassigning the at least one demand comprises changing the confirmation date of said demand to the date after said specific date.

15. A computing system programmed to perform operations for checking availability of a ware for a set of demands requesting the ware, the operations comprising:
obtaining a first data structure comprising dates in a predetermined time interval, supply information for the ware associated with said dates and demand information for the ware associated with said dates;
determining, for each of said dates in reverse order starting from a last date of said predetermined time interval, whether an overconfirmation for the ware is present on a specific date by comparing the supply information and the demand information; and
when an overconfirmation is present on the specific date, eliminating the overconfirmation before proceeding with any subsequent overconfirmation determination by reassigning at least one demand on or before the specific date to a date after the specific date.

16. The computing system of claim 15, further comprising:
obtaining a second data structure comprising said set of demands and including priority information for the demands; and
when the overconfirmation is present on the specific date, selecting the demand in the second data structure with a lowest priority to be reassigned.

17. The computing system of claim 16, wherein reassigning said at least one demand comprises reassigning the demands in the second data structure starting from the demand with the lowest priority until the overconfirmation is no longer present on said specific date.

18. The computing system of claim 15, wherein said set of demands comprises a confirmation date indicating on which date each demand is to be met and a confirmation quantity indicating a quantity requested by said demand for said confirmation date.

19. The computing system of claim 18, wherein reassigning the at least one demand comprises changing the confirmation date of said demand to the date after said specific date.
